(19) United States
(12) Patent Application Publication
(10) Pub. No.: US 2008/0015935 A1
(43) Pub. Date: Jan. 17, 2008

(54) Method of Managing a Resource

(75) Inventor: Simon Ford, Sydney (AU)

Correspondence Address: COHEN, PONTANI, LIEBERMAN & PAVANE, 551 FIFTH AVENUE, SUITE 1210, NEW YORK, NY, 10176, US

(73) Assignee: WORLD SYSTEMS CORP. LTD., GIBRALTAR (GB)

(21) Appl. No.: 11/628,381

(22) PCT Filed: Jun. 28, 2005
(86) PCT No.: PCT/AU05/00940

§ 371 Date: Dec. 1, 2006

(30) Foreign Application Priority Data
Jun. 28, 2004 (AU) 2004903496
Jul. 7, 2004 (AU) 2004903692

(51) Int. Cl. G06Q 30/00

(52) U.S. Cl. 705/14

(57) ABSTRACT

A method for management of a resource by a community of participants comprising: (a) defining individual tasks necessary for managing the resource; (b) allocating a quantum of redeemable reward points to each defined task; (c) defining participants within the community to execute tasks for reward points; (d) selecting rewards which may be redeemed by surrendering reward points earned by participants and allocation of values to each reward expressed in reward points; (e) providing an information system which enables participants to view and claim available rewards; and (f) providing an information system which keeps track of tasks, points and rewards associated with participants.

### FIELD OF THE INVENTION

The present invention relates to a method for management of a resource by a community of participants and in particular a method which involves allocation of reward points redeemable against rewards in return for the execution of tasks; the system providing for tracking and publication of reward points earned by participants in order that participants may be encouraged to greater levels of participation and in order that information may be obtained concerning diligence of participants.

### BACKGROUND OF THE INVENTION

For a number of years reward points systems have been used by organisations such as airlines, credit-card providers and retailers in order to enhance customer loyalty and lure customers by the provision of added value in the form of prizes.

These reward points systems are however fairly simple in that the rewards are earned in the course of simple financial purchase transactions which are easy to document. Existing reward points systems are not well adapted to applications such as management of tasks necessary to achieve certain objectives in relation to a resource. For example with share accommodation or fraternity houses is often difficult to ensure that occupants perform certain tasks in order to maintain a comfortable clean living environment for the benefit of all occupants. Furthermore current reward points systems for example do not provide for publication of reward points earnings in an environment which generates competition among participants or embarrassment and identification for low-level participants.

### OBJECT OF THE INVENTION

Accordingly it is an object of the present invention to provide a method of managing a resource utilising a reward points system which encourages high levels of participation and provides the invention manager with information concerning the diligence of participants with respect to management of the resource to which the invention is applied. Alternatively the present invention provides the market with an alternative to existing systems.

Alternatively according to another aspect of the current invention it is an object of the present invention to provide a method of advertising which provides enhanced exposure to those advertisers offering rewards to members of a credit point rewards scheme whose rewards are subject of a high redemption rate amongst members. Alternatively the present invention provides advertisers an alternative to advertising available by way of prior art reward points schemes.

### SHORT SUMMARY OF THE INVENTION

According to one aspect of the present invention there is disclosed a method for management of a resource by a community of participants comprised of the steps of,
a) defining individual tasks necessary for management of the resource;
b) allocation of a quantum of redeemable reward points to each defined task roughly proportional to the level of contribution required by the task;
c) defining participants within the community to execute tasks for reward points;
d) selecting rewards which may be redeemed by surrendering reward points earned by participants and allocation of values to each reward expressed in reward points;
e) providing an information system which enables participants to view and claim available rewards;
f) providing information system which keeps track of tasks, points and rewards associated with participants.

According to another aspect of the present invention there is disclosed a method of advertising whilst performing a method for management of a resource by a community of participants as lastmentioned comprising the additional steps of,
g) Allocating reward points to members of a participating group in accordance with a set of rules;
h) selecting product or goods suppliers, herinafter called reward partners, seeking publicity and willing to supply free or cut price goods or services as rewards to credit point holding participants in return for advertising or publicity,
i) setting the quantum of credits required to redeem offered rewards according to a scheme whereby the quantum of credits required for each reward is roughly proportional to the dollar value of that reward;
j) providing a medium which facilitates selling the rewards to credit point holders within the participating group.
k) presenting available awards to participants via a medium which also displays with preferential prominence to participants those reward partners whose rewards have been most redeemed by participants during a recent time period as measured by the number of credits which have been spent.
l)

According to a further aspect of the present invention there is disclosed a method for management of a resource by- a community of participants comprised of the steps of,
m) defining individual tasks necessary for management of the resource;
n) allocation of a quantum of redeemable reward points to each defined task roughly proportional to the level of contribution required by the task;
o) defining participants within the community entitled to voluntarily claim and execute tasks for reward points;
p) defining participants within the community to whom tasks may be allocated on a non voluntary basis;
q) selecting rewards which maybe redeemed by surrendering reward points earned by participants and allocation of values to each reward expressed in reward points;
r) defining individual participants authorized to check whether tasks have been adequately performed by participants and hence whether all or any reward points associated with that task will be allocated to the participant who performed the task;
s) providing an information system which enables participants to view and claim available tasks for selection;
t) providing an information system which enables participants to view and claim available rewards;
u) providing an information system which enables participants to view their rewards points earnings relative to other selected participants;
v) providing information system which keeps track of tasks, points and rewards associated with participants.
w) providing an information system which identifies tasks which are not being claimed by participants at a frequency which is desirable for the efficient management of the resource and providing a system of review for potential re-evaluation of the quantum of redeemable reward points which is currently allocated to such tasks.

### PREFERRED MODE OF CARRYING OUT THE INVENTION

One embodiment of the present invention will now be described with reference to a share accommodation resource although it should be appreciated that the present invention is not restricted to usage in connection with the resource of shared accommodation.

It is envisaged that the share accommodation property manager should be able to reduce the vacancy rate associated with a property by use of the present invention and achieve other cost savings due to the efficient performance of maintenance tasks by occupants rather than by paid staff. Occupants of share accommodation should find the scheme attractive as it should result in a better living environment, an opportunity to obtain discounts on services and products, the possibility of cheaper rent (should the operator pass on cost savings) as well as a potentially closer relationship with co-occupants brought about by co-operation in the method of the present invention and a feeling of trying to achieve common goals.

These benefits are achieved by the occupants of the accommodation, who are the participants in the scheme, accepting responsibility for performing certain tasks (e. g. cleaning a designated area) and in return the customer will earn rewards points for performing that task. The reward points can be redeemed with discounts on services and products offered by reward partners, who are the suppliers or offerers of the rewards (advertisers), such as Qantas, Starbucks, AT&T or even the landlord.

It is envisaged that potential reward partners will find the share accommodation property market an attractive market place in which to invest advertising dollars via a reward partners scheme and method in accordance with the present invention due to the fact that for example the fraternity house marketplace is a young well defined market which such a reward point scheme as is hereinafter described accurately targets. Other marketplaces maybe accurately targeted for advertising using other types of reward point schemes other than the University share accommodation

The software necessary to administer the invention is supplied to property owners free of charge and the participants would pay a small weekly administration fee (say $2.00). Reward Partners receive advertising on the website through which the method of the invention is performed via appropriate software in return for offering the rewards to participants.

The software utilised on the website through which the reward partners, occupant participants and the property owner or manager interface with the invention comprises management tools for the operator, a customer interface, a reward program and data base consisting of the participants profile. The software could be either Internet or intranet based.

The software contains five portals, one each for the occupant participants, the property owner or manager, the reward partners, charity organisations and the organisation responsible for operating the invention.

The components of the software available to the occupants participants are:
Registration;
Customer's home;
Customer's tasks;
Customer's transactions;
Customer's rewards;
Customer's notices;
Customer's messages;
Customer's Profile;
Customer's resume;
Customer's Response Profile;
Customer's accommodation history;
Customer's house mate profile;
Account Management—account details;
Account management—rent payment;
Account management—loans;
Account management—Contract Management;
Account Management—bed change;
Account management—departure notice;
Account management—transactions;
Account management—rewards;
Account management—lodger statistics;
Find a home;
Find a home—booking;
Viewing Planner
House/state/national league;
Customer make a request—maintenance;
Customer make a request—Contact Management;
Reward programmes;
View noticeboard;
Jobs available;
Blogging.
Customer's account;
Dating

The components of the software available to the operator would be;
Rewards management;
Suppliers and inventory
Staff management;
Inspections;
Inquiry management;
Merchandising;
Call centre management;
Front desk operations (check-in/out to; rewards, redemptions, etc);
Task management;
Occupancy management;
Reports;
Credit management;
Promotions;
Tour management;
Swipe card interface;
Maintenance;
Message board;
Mail templates and notification (SMS, E-mail);
Jobs management;
Accounting;
Third party investigation.

The software will also contain third party integration facilities for reward partners, affiliates, service providers and banks.

When applied to a resource such as accommodation the present invention can minimise or even eliminate staff necessary to manage accommodation and can substitute for on-site management and maintenance staff or a managing agent in many situations.

Ideally the method of the present invention is administered via the internet and appropriate software to which all relevant parties have partial or full access.

Traditionally the larger a shared living community becomes the less accountable the individuals living in it become towards their role in it to the point where the number gets out of control and you need to employee a controlled management or 3rd party carer to manage the process. The current invention's provision of transparency between occupants ensures that accountability amongst individuals remains higher as the number of occupants increase.

Reward categories offered to persons in a share accommodation situation may for example fall into five categories being; food, entertainment, travel, shopping, and accommodation (including discounts on the shared accommodation subject of the method).

Each of these rewards may be offered in four different types being discounts, zero dollar offers, last-minute deals and zero dollar deals with an associated purchase.

The reward categories are largely self-explanatory although the types of rewards may be defined as follows. A zero dollar offer is a reward offered at no dollar expense apart from the redemption of points. For example a reward partner may offer a free entry passes valued at $25 for a first 100 participants in the share accommodation scheme to redeem such passes each Saturday night at its nightclub.

A last-minute deal may occur when a reward partner realises that they have excess stock or excess capacity in services which they are offering and consequently they can offer their goods or services at a very significant discount which it may be convenient to define in most applications as in excess of 50 per cent.

A zero dollar with a purchase deal occurs when a participant makes a purchase of a product and is offered another product or service at no extra charge. For example a motor vehicle may be purchased and free airconditioning is offered in return for redemption of points.

Ideally points earned via the invention should equate to one dollar value in relation to redeemable goods or services. A reward partner offering goods or services as rewards in return for the publicity associated with the invention would therefore indicate the appropriate dollar value of the discount, free goods or deal which they are offering. Participants would have to surrender a corresponding number of points in order to redeem the goods or service comprising that reward.

In order to prevent reward partners overvaluing their rewards and clogging up the system with worthless or undesirable rewards the software associated with the present invention should present each reward within its appropriate category to participants with an indication as to the rewards which are most popular or that have been the subject of the most redemption points. Ideally those rewards which have been the subject of most redemption points should also be presented first and in a more prominent manner.

The invention as applied to share accommodation may encompass both staff and occupants in the points incentive scheme. If for example tasks are not taken up by the occupants on a voluntary basis then the staff must be allocated the unperformed tasks on a compulsory basis in accordance with predetermined criteria. If it is considered desirable to avoid the use of staff in relation to certain tasks which are not being performed then a revision of the points allocated to that particular task may be made in order to increase the attractiveness of the task and associated points to voluntary participants.

Points allocated in return for performance of a particular task should roughly correspond with the time taken to perform the task. The system may provide for checking of tasks performed by participants either on a random basis or where it is considered desirable as a matter of course. The checking operation is itself a task although it may be considered desirable that the checking be performed by a group of participants other than all co-occupants. The checking may for example be performed by staff or participants whose profiles indicate that they have been enthusiastic and reliable participants for some time.

The checking operation should involve a measure of the quality of performance of the task and may for example use grading such as “excellent, good, average, very average, or poor” scale. The points awarded for the performance of the task may therefore be reduced from the potential maximum according to the grading given by the person checking the performance of the task. The system could also provide for penalty points to be deducted in the case of poor performance of a task. Hence the invention layers a community's members into a hierarchy that tracks and measures a tasks state in a multitude of levels that are defined by an individual's expected level of accountability within the community.

Each individual task may be tracked by the invention through its life from its inception as a new task in a state of not being completed to being in a state of having its completion delayed or to being in a state of completion.

The invention through its layering of accountability within a community base can both monitor individual tasks as well as measure the quality of the tasks within its completed state by assigning ownership of the each task to individuals within the community. The invention breaks working communities' overall objectives into a group of individual tasks needed to be completed before the objective can be realised.

Profiles of individual participants may be maintained and used as references for future share accommodation applications by the individual as both property owners and potential co- occupants alike would have an interest in viewing such profiles to assess the suitability of the potential new co-occupant.

The invention therefore co-ordinates and motivates staff and customer bases into becoming a human resource that will better assist in the maintenance of business objectives through a rewards system and unit measure.

The software of the present invention and its interface with both reward partners and participants can provide certain additional incentives to both reward partners and participants.

For example as an incentive to reward partners the software and web page through which participants interface with the invention may provide a link to a page called “Rewards Partners Premiership League” where all rewards partners from both global and local rewards schemes are listed from the most successful partner down The partner who has collected the most rewards points from participants is deemed the most popular rewards partner. This “Premiership” ladder may highlight the date the partner entered the League, the total number of rewards offers they have provided since entry, total rewards points collected, total amount of money saved by participants buying these offers and an average amount of money saved per transaction. Most importantly from the reward partners point of view incentives in the nature of enhanced advertising will be given to those reward partners against whom most reward points have been redeemed. This may be by carrying the reward partners Trademark or banner on a prominent page associated with the administration of the system or ensuring that popular pages associated with the system can only be accessed after the page displaying the “Rewards Partners Premiership League” has been displayed.

Participants will automatically be entered in a “Players' League” and one or more top credit points winners from each community will be awarded incentives at the conclusion of each predetermined time period. For example if the participants are members of a fraternity house of a US university they may be awarded bonus points if they come first second or third within the university frat houses at the end of each term. Furthermore there will be a “Players' League” ladder such that there will also be awards on a State level to each member of the highest points earning community (University) in a particular State and on a National level to each of the members of the winning State's Players' League.

The software associated with the method may also include a “High Rollers Auction Room” where reward partners offer goods and services of substantial value for redemption (say over $2,000) to the highest bidder. The bidders of course would be bidding in points and the auction may run for example for one month in order that the reward partner may receive adequate advertising exposure for their contribution. All participants in the method would be notified of the winner when the auction terminated or alternatively the win would be advertised on a prominent web page within the system administering the method. Such games serve to increase participant interest in the method as well as providing further scope for advertising by reward partners.

It should be appreciated that the present invention is by no means limited to application to a share accommodation resource. For example the owners of a hotel in Thailand may decide that their resource may be enhanced if their customers are encouraged to actively participate in certain activities and experience the cultural diversity Thailand has to offer. Reward points may therefore be offered if guests attend water aerobics classes in the main pool, visit a nearby temple, attend Thai cooking classes or relax in the pool for a specified time.

Alternatively existing reward points scheme may be enhanced by introducing a competitive environment for reward partners in accordance with the present invention whereby those reward partners offering the most redeemed deals receive enhanced exposure and advertising amongst the participants in the scheme or are separated from other advertisers and highlighted by way of qualification for supplementary aspects of the rewards points scheme such as auctions.

Alternatively participants in the “Clean up Australia” campaign could have reward points allocated in return for performing designated tasks. A $2.00 administration fee might be charged to each participant.

The claims defining the invention are as follows:

1. A method for management of a resource by a community of participants comprised of the steps of,
x) defining individual tasks necessary for management of the resource;
y) allocation of a quantum of redeemable reward points to each defined task;
z) defining participants within the community to execute tasks for reward points;
aa) selecting rewards which may be redeemed by surrendering reward points earned by participants and allocation of values to each reward expressed in reward points;
bb) providing an information system which enables participants to view and claim available rewards;
cc) providing an information system which keeps track of tasks, points and rewards associated with participants.

2. A method of advertising whilst performing the method for management of a resource by a community of participants as defined in claim 1 comprising the steps of;
dd) Allocating reward points to members of a participating group in accordance with a set of rules;
ee) selecting product or goods suppliers, herinafter called reward partners, seeking publicity and willing to supply free or cut price goods or services as rewards to credit point holding participants in return for advertising or publicity;
ff) setting the quantum of credits required to redeem offered rewards according to a scheme whereby the quantum of credits required for each reward is roughly proportional to the dollar value of that reward;
gg) providing a medium which facilitates selling the rewards to credit point holders within the participating group.
hh) presenting available awards to participants via a medium which also displays with preferential prominence to participants those reward partners whose rewards have been most redeemed by participants during a recent time period as measured by the number of credits which have been spent.

3. A method for management of a resource by a community of participants comprised of the steps of,
ii) defining individual tasks necessary for management of the resource;
jj) allocation of a quantum of redeemable reward points to each defined task roughly proportional to the level of contribution required by the task;
kk) defining participants within the community entitled to voluntarily claim and execute tasks for reward points;
ll) defining participants within the community to whom tasks may be allocated on a non voluntary basis;
mm) selecting rewards which may be redeemed by surrendering reward points earned by participants and allocation of values to each reward expressed in reward points;
nn) defining individual participants authorized to check whether tasks have been adequately performed by participants and hence whether all or any reward points associated with that task will be allocated to the participant who performed the task;
oo) providing an online real time information system which enables participants to view and claim available tasks for selection;
pp) providing an online real time information system which enables participants to view and claim available rewards;
qq) providing an online real time information system which enables participants to view their rewards points earnings relative to other selected participants;
rr) providing an online real time information system which keeps track of tasks, points and rewards associated with participants.
ss) providing an online real time information system which identifies tasks which are not being claimed by participants at a frequency which is desirable for the efficient management of the resource and providing a system of review for potential reevaluation of the quantum of redeemable reward points which is currently allocated to such tasks or the voluntary/non voluntary status of such tasks.

4. A method in accordance with claim 3 hereof wherein there is software and a viewable screen through which participants interface with the invention which screen additionally provides a link to a second location on the system where all rewards partners from selected rewards schemes are listed from the most successful partner down.

5. A method in accordance with claim 3 hereof wherein there is software and a viewable screen through which participants interface with the invention which screen additionally provides a link to a second location on the system where incentives in the nature of enhanced advertising will be given to those reward partners against whom most reward points have been redeemed
